(19) United States
(12) Patent Application Publication
(10) Pub. No.: US 2025/0160312 A1
(43) Pub. Date: May 22, 2025

(54) MOUSETRAP

(71) Applicants: Philip Marvin Hardison, Pantego, NC (US); Donna Respass Hardison, Pantego, NC (US)

(72) Inventors: Philip Marvin Hardison, Pantego, NC (US); Donna Respass Hardison, Pantego, NC (US)

(21) Appl. No.: 18/770,832

(22) Filed: Jul. 12, 2024

Related U.S. Application Data
(63) Continuation-in-part of application No. 18/514,534, filed on Nov. 20, 2023, now abandoned.

(51) Int. Cl. A01M 23/24; A01M 23/00

(52) U.S. Cl. CPC A01M 23/245; A01M 23/005

(57) ABSTRACT

A mousetrap having a tangle of string applied to one side of a two-sided sticky material and the other side of the material applied to the bait plate. The tangle of string catches the rodent's teeth as it eats the bait and increases likelihood of a kill or capture.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a mousetrap. In particular, it relates to a mousetrap improvement that catches more mice or other rodents than other systems.

### Description of Related Art

The use of mousetraps is ubiquitous. A wide array of “better mousetraps” have been introduced over the years. However, newer ones tend to be more complicated and therefor more expensive. Accordingly, the majority of mousetraps are the inexpensive traps consisting of a base, a bait plate and a spring-loaded kill bar. The user places bait on the bait plate and when the mouse steps on the bait plate to eat the bait, the mouse's weight triggers the kill bar to engage. Some mice are more clever than others and figure a way to eat the bait off the bait plate without putting any weight on the bait plate. The user then finds the mousetrap with missing bait, but the trap did not engage.

One solution is to elongate the bait plate and make it “T” shaped to hold the bait. The bait is then held down by two non-overlapping strings that are fed through a hole in the bait plate. But this arrangement doesn't trap the teeth of the rodent and requires a new type of mousetrap construction that doesn't work with peanut butter nor is transferrable to other mousetraps.

### BRIEF SUMMARY OF THE INVENTION

The present invention relates to an improved mousetrap that overcomes the drawbacks of existing mouse traps with a standard bait plate (standard length). It has been discovered that instead of just a simple piece of metal for a bait plate the bait plate is covered with a two-sided sticky material. A tangle of string is stuck on the top of the two-sided sticky material that traps the mouse's teeth and makes it difficult for the mouse to remove itself without triggering the mousetrap. The present invention engages the mouse's teeth on the tangle of string making it impossible for the mouse to withdraw quickly and causes the mouse to put pressure on the bait plate in an attempt to get free. The string can be string, dental floss, or the like, the teeth get engaged in the tangle of string, preventing quick withdrawal of the mouse and puts pressure on the bait plate triggering the mousetrap kill bar.

Accordingly, in one embodiment, there is a mousetrap with a bait plate designed to trap a rodent's teeth consisting of:
a) two-sided piece of tape, having a top and bottom side;
b) a tangle of string overlapping at least 5 times; and
c) wherein the tangle of string is applied to the top side of the two-sided tape and the bottom of the two-sided tape is applied to the bait plate.

### BRIEF DESCRIPTION OF THE DRAWINGS

FIG. 1 is a perspective of a mousetrap with added two-sided sticky tape attached to the bait plate and a tangle of dental floss on the sticky tape.

FIG. 2 is the mousetrap with the mouse's teeth trapped in the tangle of string.

FIG. 3 is the tangle of string stuck on the sticky material.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean ±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

It is further noted that the claims may be drafted to exclude any element which may be optional. As such, this statement is intended to serve as antecedent basis for use of such exclusive terminology as “solely”, “only” and the like in connection with the recitation of claim elements, or the use of a “negative” limitation.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. To the extent such publication may set out definitions of a term that conflict with the explicit or implicit definition of the present disclosure, the definition of the present disclosure controls.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “mousetrap” refers to a device with a bait plate for trapping or killing mice and other rodents. This is accomplished by placing bait (anything a rodent will want to eat e.g. peanut butter) on the bait plate. When the rodent steps on the bait plate, or presses on the bait plate, to eat the bait, it releases a kill bar to capture or kill the rodent. These types of mousetraps have been around for decades.

As used herein, the term “bait plate” refers to the trigger on a mousetrap where bait is placed in order to attract a rodent. The trigger activates the mousetrap when pressure is put on the bait plate. When the rodent tries to grab the bait, if it puts weight on the bait plate, it triggers the mouse trap. In this invention, it can be a flat piece of metal. As described above, substantial number of rodents figure out how get the bait off of a mousetrap without triggering the mousetrap by gingerly eating the bait, thus not putting pressure on the bait plate. By use of a tangle of string in the present invention, the rodent will get its teeth tangled in the tangle of string and becomes more likely to trigger the mousetrap as the rodent struggles to release themselves from the tangle of string. In one embodiment, the bait is applied in between openings in the tangle of string.

As used herein the term “two-sided sticky material” refers to a piece of two-sided tape or the like where one side is attached to the bait plate and the other side is for placing the tangle of string.

As used herein, the term “tangle of string” refers to a material applied to the two-sided sticky material that can trap the teeth of the rodent, thus causing the rodent to struggle and trigger the mousetrap. The tangle of string refers to string (e.g. dental floss and the like) that is wadded up so that the string criss-crosses itself at least 5 times and in one embodiment at least 10 times. Bait (peanut butter or other thick and spreadable bait) is positioned on the top surface of the tangle of string so that at least some portion of the thick and spreadable bait slips down into the tangle of string, forcing the rodent to get its teeth caught in the tangle in order to eat the bait and trigger the mousetrap.

As used herein, the term “applied” refers to placing the two-sided sticky material on the bait plate with the tangle of string placed on top of the two-sided sticky material. Strings refers to string, dental floss, and the like.

### DRAWINGS

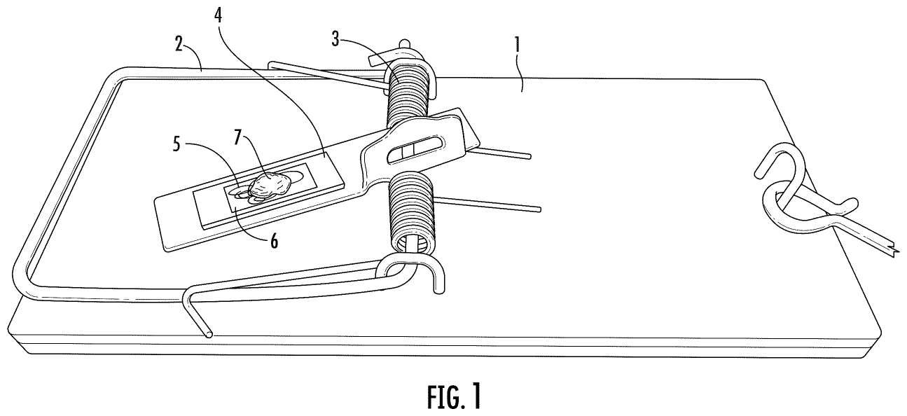

Now referring to the drawings, FIG. 1 is a mousetrap of the present invention. The mousetrap 1 consists of kill bar 2, spring 3 for driving the kill bar 2. Further it has bait plate 4. In this embodiment a single string of dental floss 5 is tangled in an overlapping manner and placed on two-sided tape 6 and stuck on top of the bait plait 4 as trapping material to entangle a rodent's teeth when the rodent is trying to steal or eat the bait.

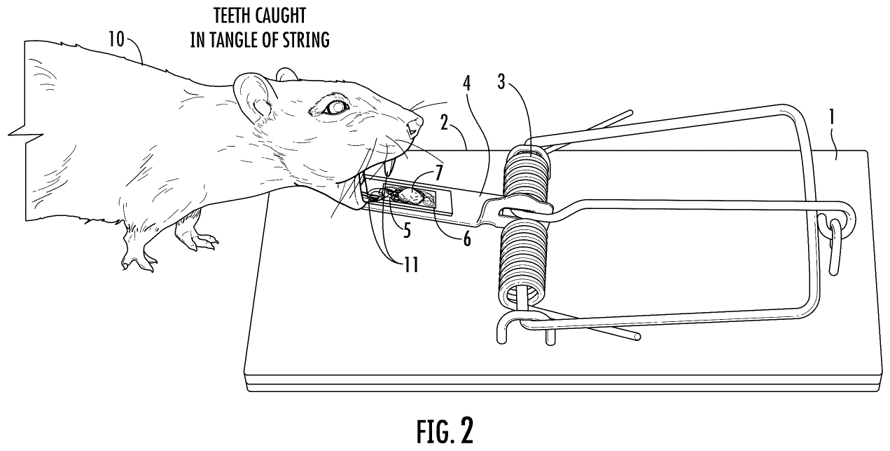

FIG. 2 is a view of mousetrap 1 showing the rodent 10 and front teeth 11 wherein the teeth 11 have entangled with the tangle of string 5 trapping the rodent. When the rodent tries to free itself, it sets off the trap. In this view, peanut butter 7 is placed on the tangle of string 5.

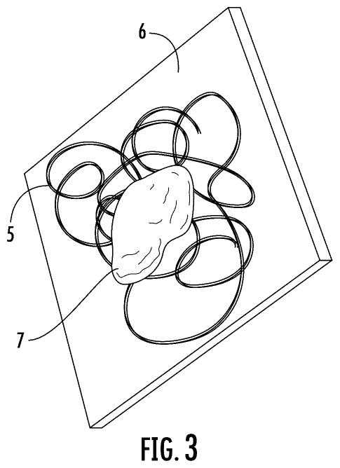

FIG. 3 is a perspective view of two-sided tape 6 and the tangle of string 5. It can be clearly seen that the string overlaps itself at least 10 times. It is also noted that the tape-string assembly can be used on any bait plate and be easily replaced.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. (canceled)

2. (canceled)

3. (canceled)

4. A device for placement on a mousetrap bait plate consisting of a tangle of string applied to one side of a two-sided sticky material.
